(19) United States
(12) Patent Application Publication
(10) Pub. No.: US 2010/0270805 A1
(43) Pub. Date: Oct. 28, 2010

(54) Magnetically Levitated Wind Turbine

(76) Inventor: Sanza T. Kazadi, Alhambra, CA (US)

Correspondence Address: Dr. Sanza T. Kazadi, 515 S. Palm Ave., #3, Alhambra, CA, 91803, US

(21) Appl. No.: 12/427,751

(22) Filed: Apr. 22, 2009

(51) Int. Cl. F03D 9/00; H02K 7/09

(52) U.S. Cl. 290/55; 310/90.5

(57) ABSTRACT

A wind turbine is provided which is mounted on a permanent magnetic male and female levitation support as described in U.S. Pat. No. 7,501,922. The wind turbine has a main axle which is levitated relative to a permanent magnet assembly and has one or more stationary points of contact with a static rigid frame. The wind turbine may be utilized to generate power using a generator or alternator. In one instantiation, one part of the alternator is mounted on the main axle, while the other is on the rigid frame.

This patent, created by Dr. Sanza T. Kazadi, a United States Citizens, residing in Alhambra, Calif., concerns itself with a magnetically levitated wind turbine. The wind turbine is levitated utilizing a permanent magnetic male and female levitation support which allows one part of the wind turbine to rotate relative to a second part while being levitated above the second part. The defining axis of the permanent magnetic male and female levitation support may be aligned vertically so as to align the repulsion axis of the magnetic fields of the two support components with the direction of gravity, and provide support for the whole weight of the mobile portion of the machine.

The current machine is novel in that part or all of the weight of the mobile portion may supported by the magnetic fields generated by the male and female levitation supports, and that the axis is stable because of the qualities of the magnetic fields and rigidity of the axle alone. Moreover, in one embodiment, the floating part of the wind turbine contains the mobile part of the generator or alternator used to generate electricity.

### FIELD OF THE INVENTION

This invention relates to the field of energy generation utilizing wind and to magnetically levitated machinery.

### SUMMARY OF THE PRIOR ART

### Citations:

| | | |
|---|---|---|
| 247,266 | Wind Vehicle | Miller |
| 1,076,713 | Air or Water Motor | Southwick |
| 6,700,216 | Magnetically Levitated Windmill | Vann |
| 7,501,922 | Permanent magnetic male and female levitation | Kazadi |
| | supports | |

Wind turbines are devices which rotate in the presence of wind, and can be used for a variety of purposes. Direct mechanical work done by the wind turbine has been accomplished for eons in areas including manufacturing, farming, and food production (U.S. Pat. No. 247,266 is an example). Coupling the wind turbine to a generator or alternator provides electricity which can be stored or transmitted for virtually unlimited additional purposes.

There are two general classes of wind turbines. Horizontal axis wind turbines have a rotational axis parallel to the ground. These turbines must be turned into the wind using a yaw device to obtain maximal torque. Vertical axis wind turbines have a rotational axis perpendicular to the ground. (An example is U.S. Pat. No. 1,076,713.) These turbines, while lacking the yaw device, can have problems with excessive rotational speeds and maintenance difficulties.

Most wind turbines are supported by one or more bearing assemblies. These assemblies hold the turbine in place and allow its rotation, minimizing friction. Despite the reduction of friction, friction in a wind turbine is a significant issue. It can limit the useful force available for power generation, and inevitably leads to damage which renders the wind turbine inactive.

As a result of the need to reduce friction, a magnetically levitated wind turbine was disclosed in U.S. Pat. No. 6,700,216. This turbine generates a current when in production which powers a set of electromagnets. These electromagnets provide the levitation force which disengage support bearings, allowing friction-free operation. However, this use of power reduces available power for delivery, and it is not clear from the patent what percentage of total generated power is then available. Moreover, deactivation of some portion of the electromagnetic array due to any electrical or mechanical fault renders the array not only inactive but damaging to the wind turbine.

An improvement over the use of electromagnet technology is herein provided. The technology that makes this invention possible, described in U.S. Pat. No. 7,501,922, is a permanent magnetic male and female levitation support. This support makes it possible to create an axle which has one end supported by a permanent magnetic field and the other held in place by a rigid frame at one point of contact. This axle may be laden with a payload which is fully supported by the magnetic field. The axle automatically restores its position after perturbations that tend to misalign it.

### SUMMARY OF THE INVENTION

The present invention is a wind turbine in which the wind sails are mounted on an axle that utilizes a permanent magnetic male and female support, as described in U.S. Pat. No. 7,501,922. This allows the sails to be fully supported by the magnetic field, thereby mitigating any frictional forces that might result from the weight of the central axis. Because the axle supporting the sails is levitated above a magnetic base, it does not require ball bearings or bearing assemblies, thereby reducing the cost and complexity of the resulting wind turbine.

In one instantiation, the central axis also supports part of an alternator which provides electrical energy when the central axis is rotating with respect to a stationary support structure. This arrangement allows the alternator to generate energy without the need for gears, pulleys, belts, or other methods of transferring the rotational energy to the alternator. The lack of such implements reduces energy losses due to friction. It also reduces the wear and tear of the device, improving its lifetime.

In another instantiation, the central axis supports part of a generator which provides electrical energy when the central axis is rotating with respect to a stationary support structure. This arrangement allows the alternator to generate energy without the need for gears, pulleys, belts, or other methods of transferring the rotational energy to the alternator. The lack of such implements reduces energy losses due to friction. It also reduces the wear and tear of the device, improving its lifetime.

### BRIEF DESCRIPTION OF THE DRAWINGS

The accompanying drawings illustrate the invention. In such drawings:

FIG. 1 is a simplified version of the wind turbine;

FIG. 2 is a version of the wind turbine with an attached alternator;

### DETAILED DESCRIPTION OF THE PREFERRED EMBODIMENTS

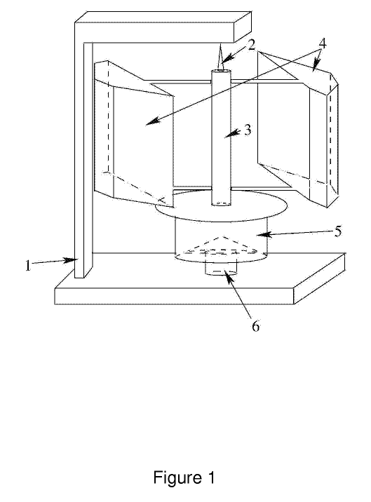

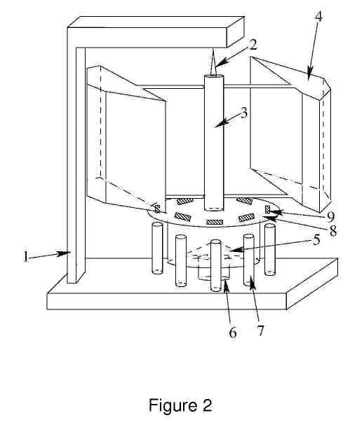

As shown in FIGS. 1 and 2 for purposes of illustration, the present invention is a wind turbine whose activity is mediated by a magnetically levitated axle.

The simplified embodiment comprises three principle components:
(1) A rigid stationary support structure (1)
(2) A magnetically levitated axle structure (2,3,5, and 6)
(3) A payload supported by the magnetic levitation (4)

The rigid stationary support structure (1) is a structure holding the male part of the permanent magnetic male and female levitation support rigidly in place with respect to the remainder of the structure as well as providing a stationary point or structure for the topmost part of the magnetically levitated axle to contact. Enough space exists between the two parts of the support structure to allow rotation of the axle structure, though the rotation may be constrained by the same support structure.

The magnetically levitated axle structure (2,3,5, and 6) consists of a permanent magnetic male and female levitation support (as described in U.S. Pat. No. 7,501,922). The male portion of the permanent magnetic male and female levitation support is rigidly attached to the support structure of the wind turbine. The topmost portion of the axle contacts the support structure in such a way that it is constrained to contact at one or more stationary points and that it is possible for the axle to rotate in part or completely about that point or points.

The payload (4) is attached to the axle structure in such a way that its entire weight is supported the axle, and arranged in such a way that it does not impede the rotation of the axle about the stationary point or points of contact with the rigid support structure. The payload consists of a vane or vanes which, when acted on by a constant or semi-constant wind source, induce a rotational motion of the axle upon which they are mounted.

In another embodiment illustrated in FIG. 2, the payload consists of an added assembly of magnets (9) arranged on a support structure. An assembly magnetic pickups which transform the varying magnetic fields induced due to rotation of the axle into electrical current is positioned underneath the magnets.

1. A wind turbine comprising:
a first stationary and rigid support structure;
a first axle utilizing the permanent magnetic male and female levitation support described in U.S. Pat. No. 7,501,922 which is held in place by contact with one or more points on said first stationary and rigid support structure and the magnetic field associated with said permanent magnetic male and female levitation support;
a payload mounted on said axle and supported by the magnetic fields of the axle, which induces a rotational motion of said first axle in the presence of wind;
wherein said axle rotates in the presence of wind, maintaining its orientation, contact with said stationary and rigid support structure, and separation of the male and female parts of said permanent magnetic male and female levitation support.

2. The wind turbine of claim one wherein a two-part alternator is built into the wind turbine. The first part of said alternator is mounted on said first axle and the second part of the alternator is mounted on said first stationary and rigid support structure or a second independent stationary and rigid support structure. Rotation of said first axle generates an electrical current in the alternator.

3. The wind turbine of claim one wherein a two-part generator is built into the wind turbine. The first part of the generator is mounted on said first axle and the second part of the generator is mounted on said first stationary and rigid support structure or a second independent stationary and rigid support structure. Rotation of said first axle generates an electrical current in the generator.

4. The wind turbine of claim one wherein mechanical energy is transferred to a secondary structure using one or more magnets attached to said first axle, which induce motion in another device either built into said first stationary and rigid support structure, or rigidly held nearby said first axle by a second stationary support structure.

5. The wind turbine of claim one wherein mechanical energy is transferred to a secondary structure utilizing a secondary mechanical system such as a belt, set of belts, or a gearing system to transfer mechanical energy from said first axle to said secondary mechanical system.

6. The wind turbine of claim one wherein the axis of the wind turbine is not aligned with the gravitational field.
